(19) United States
(12) Patent Application Publication
(10) Pub. No.: US 2015/0136470 A1
(43) Pub. Date: May 21, 2015

(54) SELECTION METHOD FOR STRONG WIND REGION COMPOSITE INSULATOR BASED ON STRUCTURE PARAMETERS, AND COMPOSITE INSULATOR

(71) Applicant: Graduate School at Shenzhen, Tsinghua University, Shenzhen, Guangdong (CN)

(72) Inventors: Zhidong Jia, Shenzhen (CN); Zhengyi Zhu, Shenzhen (CN); Xilin Wang, Shenzhen, Guangdong (CN); Zhicheng Guan, Shenzhen (CN); Guoxiang Ma, Shenzhen (CN)

(21) Appl. No.: 14/400,791

(22) PCT Filed: Oct. 30, 2013
(86) PCT No.: PCT/CN2013/086265

§ 371 Date: Nov. 12, 2014

(51) Int. Cl. H02G 7/14; G01B 21/10; G01B 21/16; H01B 17/02

(52) U.S. Cl. CPC H02G 7/14; H01B 17/02; G01B 21/10; G01B 21/16
USPC 174/40 R; 702/189

(57) ABSTRACT

A selection method for a strong wind region composite insulator based on structure parameters, and a composite insulator are disclosed. When a selection is made among a plurality of composite insulators according to the selection method, structure parameters of the composite insulators are measured first, and then the selection is made according to certain ranges of the parameters, a selected composite insulator is tested, and it is found that it may withstand strong wind climate environments where the highest wind speed reaches 50 m/s. The composite insulator is a composite insulator having corresponding structure parameters. The selection method is easy to operate and implement. When the composite insulator is applied to a strong wind region where the highest wind speed reaches 50 m/s, the problem of violent oscillation of umbrella skirts or tear of the umbrella skirts does not occur, and the composite insulator may still operate reliably.

### CROSS REFERENCE TO RELATED APPLICATIONS

This application is a national application of PCT/CN2013/086265, filed on Oct. 30, 2013. The contents of PCT/CN2013/086265 are all hereby incorporated by reference.

### FIELD

The present application relates to high voltage and insulation technologies, and particularly to a selection method for a strong wind region composite insulator, and a composite insulator.

### BACKGROUND

Composite insulators are devices often used in high-voltage transmission lines, which are common in telegraph poles and high-voltage wire connection towers, for fixing hanging wires, and play a role of electrical insulation between the towers and high-voltage wires. A composite insulator includes a mandrel, a sheath and a plurality of umbrella skirts, and the sheath and the umbrella skirts integrally formed are bonded with the outer side of the mandrel. The mandrel is mainly made from glass fiber, and the sheath and the umbrella skirts are made from high-temperature vulcanized silicone rubber. The silicone rubber has lower modulus of elasticity and soft texture, resulting in that the structure of the umbrella skirts has low stiffness, and thus the umbrella skirts' capability to resist bending and vibration is extremely weak.

The composite insulators are used in outdoor environments, and thus will inevitably encounter strong wind climate environments. For example, in Northwest China, there are eight famous wind regions only in the Xinjiang region. For example, the famous “fifteen-kilometer wind region” between Urumqi and Turpan, the highest average wind speed at a height of 10 m reaches 42 m/s, it is calculated according to a natural wind speed profile curve that the highest wind speed at an average nominal height of 46 m of a 750 kV tower reaches 50 m/s, which is a huge challenge for safe operation of the composite insulators: it is mentioned above that, the umbrella skirts of the composite insulators are made from silicone rubber with low modulus of elasticity, resulting in that their capability to resist bending and vibration is weak, and in the strong wind climate environments, the umbrella skirts are prone to a problem that the umbrella skirts violently oscillate under dual effects of wind pressure and flow-induced vibration. Substantial deformation leads to severe stress concentration at the chamfers of the umbrella skirts' root, and long-term cyclic stress effects lead to fatigue and relaxation of silicone rubber materials in the region, which even develop into a tear trouble. Currently, the trouble has become one of the main defensive objects of insulator trouble outside the strong wind region composite insulator, and has caused a great threat to economy and safe operation of the power system.

In the existing selection method, when a selection is made among a plurality of composite insulators, only electrical characteristics of the composite insulators are taken into account. Therefore, in the existing selection method, when a selected composite insulator is used in a strong wind region, it is prone to problems of violent oscillation of umbrella skirts of the insulator and stress concentration at roots of the umbrella skirts, that is, it is prone to root tear troubles caused by the violent oscillation of the umbrella skirts.

### SUMMARY

The technical problem to be solved by some embodiments of the present application is: to make up for the aforementioned deficiencies of the prior art, and a selection method for a strong wind region composite insulator based on structure parameters, and a composite insulator are provided, where the problem of violent oscillation of umbrella skirts or tear of the umbrella skirts does not occur when the composite insulator is applied to a strong wind region.

The technical problem of the embodiments of the present application is solved through the following technical solution:

a selection method for a strong wind region composite insulator based on structure parameters, comprising the following steps: 1) measuring structure parameters of a composite insulator to be selected; when the composite insulator is in an asymmetric umbrella shape, the structure parameters comprise an umbrella skirt diameter, an umbrella skirt edge thickness, an umbrella skirt root thickness, an adjacent umbrella spacing, an upper umbrella root chamfer radius, a lower umbrella root chamfer radius and an umbrella skirt diameter difference of adjacent umbrella skirts; when the composite insulator is in a symmetric umbrella shape, the structure parameters comprise an umbrella skirt diameter, an umbrella skirt edge thickness, an upper umbrella inclination angle, a sheath diameter, an adjacent umbrella spacing, a root chamfer radius and an umbrella skirt diameter difference of adjacent umbrella skirts; and 2) selecting a composite insulator in an asymmetric umbrella shape and/or a composite insulator in a symmetric umbrella shape according to the structure parameters shown in the following tables:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | is less than 40 mm | |
| root | When an adjacent umbrella spacing | 10 mm ≦ R1 ≦ 14 mm |
| chamfer | is between 40 mm and 50 mm | |
| radius | When an adjacent umbrella spacing | 12 mm ≦ R1 ≦ 16 mm |
| R1 | is greater than 50 mm | |
| Lower | When an adjacent umbrella spacing | R2 = 12 mm |
| umbrella | is less than 40 mm | |
| root | When an adjacent umbrella spacing | 12 mm ≦ R2 ≦ 14 mm |
| chamfer | is between 40 mm and 50 mm | |
| radius | When an adjacent umbrella spacing | 14 mm ≦ R2 ≦ 16 mm |
| R2 | is greater than 50 mm | |

| | |
|---|---|
| Umbrella skirt diameter difference ΔD of | 0 ≦ ΔD ≦ 40 mm |
| adjacent umbrella skirts | |

and

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × |
| | | tanβ ≧ 13 mm |
| Umbrella | When an adjacent umbrella spacing | 10 mm ≦ R ≦ 12 mm |
| root | is less than 40 mm | |
| chamfer | When an adjacent umbrella spacing | 10 mm ≦ R ≦ 14 mm |
| radius R | is between 40 mm and 50 mm | |
| | When an adjacent umbrella spacing | 12 mm ≦ R ≦ 16 mm |
| | is greater than 50 mm | |

| | |
|---|---|
| Umbrella skirt diameter difference ΔD of | 0 ≦ ΔD ≦ 40 mm |
| adjacent umbrella skirts | |

The technical problem of the embodiments of the present application is solved through a further solution as follows:

a composite insulator, the composite insulator being of an asymmetric umbrella-shaped structure, where the structure parameters of the composite insulator are shown in the following table:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | is less than 40 mm | |
| root | When an adjacent umbrella spacing | 10 mm ≦ R1 ≦ 14 mm |
| chamfer | is between 40 mm and 50 mm | |
| radius | When an adjacent umbrella spacing | 12 mm ≦ R1 ≦ 16 mm |
| R1 | is greater than 50 mm | |
| Lower | When an adjacent umbrella spacing | R2 = 12 mm |
| umbrella | is less than 40 mm | |
| root | When an adjacent umbrella spacing | 12 mm ≦ R2 ≦ 14 mm |
| chamfer | is between 40 mm and 50 mm | |
| radius | When an adjacent umbrella spacing | 14 mm ≦ R2 ≦ 16 mm |
| R2 | is greater than 50 mm | |

| | |
|---|---|
| Umbrella skirt diameter difference ΔD of | 0 ≦ ΔD ≦ 40 mm |
| adjacent umbrella skirts | |

The technical problem of the embodiments of the present application is solved through a further solution as follows:

a composite insulator, the composite insulator being of a symmetric umbrella-shaped structure, where structure parameters of the composite insulator are shown in the following table:

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × tanβ ≧ |
| | | 13 mm |
| Umbrella | When an adjacent umbrella spacing | 10 mm ≦ R ≦ 12 mm |
| root | is less than 40 mm | |
| chamfer | When an adjacent umbrella spacing | 10 mm ≦ R ≦ 14 mm |
| radius R | is between 40 mm and 50 mm | |
| | When an adjacent umbrella spacing | 12 mm ≦ R ≦ 16 mm |
| | is greater than 50 mm | |

| | |
|---|---|
| Umbrella skirt diameter difference ΔD of | 0 ≦ ΔD ≦ 40 mm |
| adjacent umbrella skirts | |

Compared with the prior art, the embodiments of the present application may have the following beneficial effects:

According to the selection method for a strong wind region composite insulator based on structure parameters, and the composite insulator of some embodiments of the present application, when a selection is made among a plurality of composite insulators, the selection is made by measuring structure parameters of the composite insulators and according to certain ranges of the parameters, and a selected composite insulator is tested, and it is found that it may withstand strong wind climate environments where the highest wind speed reaches 50 m/s. The present application studies wind-resistant performance of an insulator when applied to a strong wind region to obtain a selection method, the method is easy to operate and implement, and when the selected composite insulator is applied to a strong wind region where the highest wind speed reaches 50 m/s, the problem of violent oscillation of umbrella skirts or tear of the umbrella skirts does not occur, and the composite insulator may still operate reliably.

### BRIEF DESCRIPTION OF THE DRAWINGS

FIG. 1 is a schematic diagram showing the structure of a composite insulator in a symmetric umbrella shape according to the present application;

FIG. 2 is a schematic view of a partial longitudinal section of the composite insulator shown in FIG. 1;

FIG. 3 is a schematic view of a partial longitudinal section of a composite insulator in an asymmetric umbrella shape according to the present application; and

FIG. 4 is a flowchart of a selection method for a composite insulator according to the embodiments of the present application.

### DETAILED DESCRIPTION

The present application is further described below in detail with reference to specific embodiments and the accompanying drawings.

The embodiments of the present application provide a selection method for a strong wind region composite insulator, which makes a selection mainly with respect to wind-resistance issues of the composite insulator in a strong wind region where the highest wind speed reaches 50 m/s, thereby solving the problem of violent oscillation of umbrella skirts of the composite insulator in strong wind environments. Generally, there are many factors affecting violent oscillation of the umbrella skirts, comprising insulator arrangement, an included angle between airflow and an insulator mandrel, a proportion of pulsation components in airflow, structure parameters of an insulator, material parameters of an insulator and the like. Upon research, it has been found that the most favorable method for solving the problem of violent oscillation of the umbrella skirts is controlling the structure parameters of the insulator. The structure parameters of the insulator comprise overall structure parameters and local structure parameters, wherein the former mainly comprises a cooperation manner of large and small umbrellas, an umbrella stretching difference, and an umbrella spacing; the latter mainly comprises an umbrella root chamfer radius, a symmetrical manner of umbrella skirts, an umbrella skirt edge thickness, an umbrella diameter, and an umbrella inclination angle. In the above parameters, the degree of influence varies. The selection method in the embodiments specifically defines a selection on the structure parameters of the insulator, and can be applied to composite insulators whose umbrella skirts have upper and lower surfaces of a symmetric structure or an asymmetric structure. When the selected composite insulator operates in an environment where the highest wind speed reaches 50 m/s, the umbrella skirts do not oscillate violently, and stress concentration of roots of the umbrella skirts is not significant. The selection method inhibits violent vibration of the umbrella skirts and alleviates stress concentration, so as to achieve the purpose that the umbrella skirts of the composite insulator are not torn in a strong wind region and the composite insulator may operate reliably.

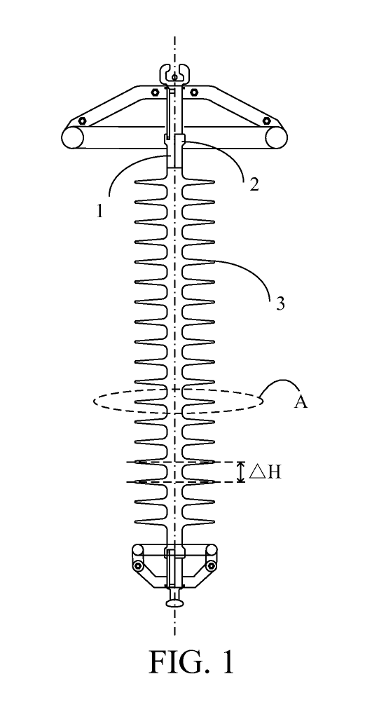

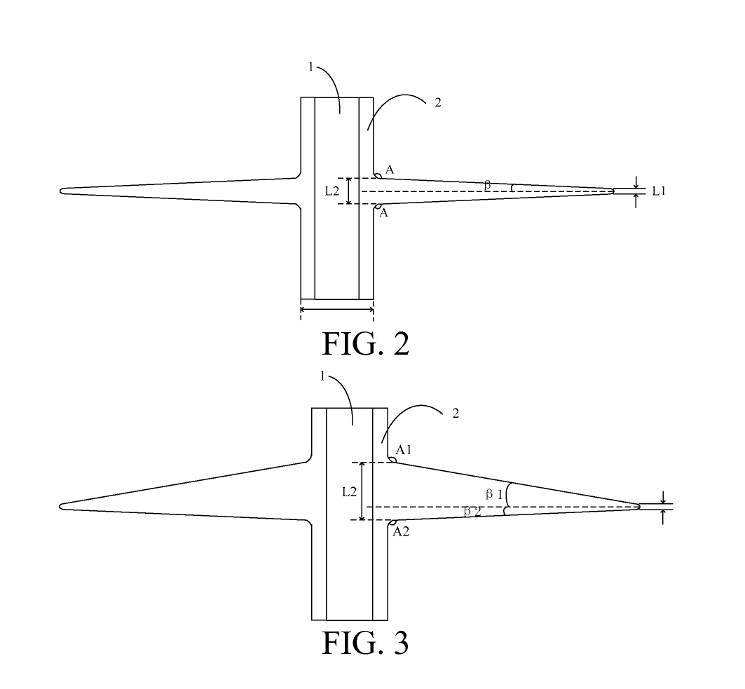

As shown in FIG. 1, FIG. 1 is a schematic diagram showing the structure of a common composite insulator in a symmetric umbrella shape. The composite insulator comprises a mandrel 1, a sheath 2 and a plurality of umbrella skirts 3. The sheath 2 and the umbrella skirts 3 integrally formed are bonded with the outer side of the mandrel 1. A symmetric structure means that upper and lower surfaces of the umbrella skirts are symmetric, and relatively, an asymmetric structure means that upper and lower surfaces of the umbrella skirts are asymmetric. As shown in FIG. 2, FIG. 2 is a schematic view of a longitudinal section at Part A of the composite insulator shown in FIG. 1, and FIG. 2 shows an umbrella skirt edge thickness L1 and an umbrella skirt root thickness L2, an upper umbrella inclination angle β, and a root chamfer A (a root chamfer radius R exists correspondingly, but is not shown in FIG. 2). FIG. 2 shows a symmetric umbrella-shaped structure, while FIG. 3 shows an asymmetric umbrella-shaped structure. FIG. 3 also illustrates an umbrella skirt edge thickness L1 and an umbrella skirt root thickness L2, and further illustrates an upper umbrella inclination angle β1, a lower umbrella inclination angle 132, an upper umbrella root chamfer A1 (an upper umbrella root chamfer radius R1 exists correspondingly, but is not shown in FIG. 3), and a lower umbrella root chamfer A2 (a lower umbrella root chamfer radius R2 exists correspondingly, but is not shown in FIG. 3). In addition, for the structure of the umbrella skirts, there are an equal-diameter structure and an unequal-diameter structure. The so-called equal-diameter structure means that umbrella skirt diameters of the umbrella skirts in the composite insulator are equal, and as shown in FIG. 1, the umbrella skirts are of an equal-diameter structure. Relatively, the unequal-diameter structure means that umbrella skirt diameters of the umbrella skirts in the composite insulator are unequal, and there are large umbrellas and small umbrellas. In the embodiments, an adjacent umbrella spacing ΔH is a spacing between two adjacent umbrella skirts. If they are umbrellas with an equal diameter, the umbrella spacing ΔH is a spacing between two adjacent umbrellas with an equal diameter. If they are umbrellas with unequal diameters, the umbrella spacing ΔH is a spacing between two adjacent umbrellas, that is, a large umbrella skirt and a small umbrella skirt.

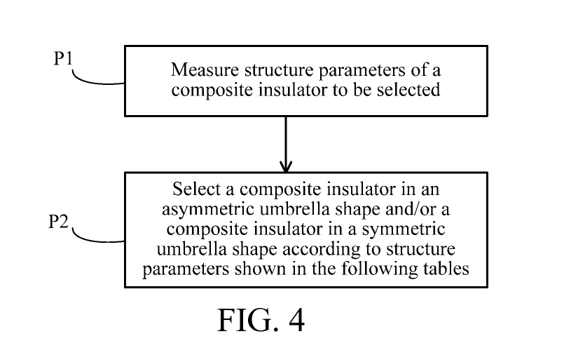

As shown in FIG. 4, FIG. 4 is a flowchart of a selection method for a composite insulator according to the embodiments. The selection method is used for selecting a composite insulator that can be used in a strong wind region (50 m/s) from a plurality of composite insulators to be selected, and even when the selected composite insulator operates in the strong wind region, the umbrella skirts are not torn and the composite insulator may operate reliably. The selection method comprises the following steps.

P1) Measure structure parameters of a composite insulator to be selected. If the composite insulator is in an asymmetric umbrella shape, the structure parameters comprise the umbrella skirt diameter D, the umbrella skirt edge thickness L1, the umbrella skirt root thickness L2, the adjacent umbrella spacing, the upper umbrella root chamfer radius R1, the lower umbrella root chamfer radius R2 and an umbrella skirt diameter difference ΔD of adjacent umbrella skirts. If the composite insulator is in a symmetric umbrella shape, the structure parameters comprise the umbrella skirt diameter D, the umbrella skirt edge thickness L1, the upper umbrella inclination angle β, a sheath diameter D1, the adjacent umbrella spacing, the root chamfer radius R and the umbrella skirt diameter difference ΔD of adjacent umbrella skirts. In measurement, a thickness gauge (thickness measurement gauge) or a tool such as a ruler is used for the measurement.

P2) Select a composite insulator in an asymmetric umbrella shape and/or a composite insulator in a symmetric umbrella shape according to structure parameters shown in the following tables:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | ΔH is less than 40 mm | |
| root | When an adjacent umbrella spacing | 10 mm ≦ R1 ≦ 14 mm |
| chamfer | ΔH is between 40 mm and 50 mm | |
| radius | When an adjacent umbrella spacing | 12 mm ≦ R1 ≦ 16 mm |
| R1 | ΔH is greater than 50 mm | |
| Lower | When an adjacent umbrella spacing | R2 = 12 mm |
| umbrella | ΔH is less than 40 mm | |
| root | When an adjacent umbrella spacing | 12 mm ≦ R2 ≦ 14 mm |
| chamfer | ΔH is between 40 mm and 50 mm | |
| radius | When an adjacent umbrella spacing | 14 mm ≦ R2 ≦ 16 mm |
| R2 | ΔH is greater than 50 mm | |

| | |
|---|---|
| Umbrella skirt diameter difference ΔD of | 0 ≦ ΔD ≦ 40 mm |
| adjacent umbrella skirts | |

and

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × tanβ ≧ |
| | | 13 mm |
| Umbrella | When an adjacent umbrella spacing | 10 mm ≦ R ≦ 12 mm |
| root | ΔH is less than 40 mm | |
| chamfer | When an adjacent umbrella spacing | 10 mm ≦ R ≦ 14 mm |
| radius R | ΔH is between 40 mm and 50 mm | |
| | When an adjacent umbrella spacing | 12 mm ≦ R ≦ 16 mm |
| | ΔH is greater than 50 mm | |

| | |
|---|---|
| Umbrella skirt diameter difference ΔD of | 0 ≦ ΔD ≦ 40 mm |
| adjacent umbrella skirts | |

In the specific embodiments, an appropriate composite insulator is selected according to the above method, so as to be applicable to a strong wind region.

For the composite insulator in an asymmetric umbrella shape, preferably, in step P2), in the table, the upper umbrella root chamfer radius R1 is in the following range of: 10 mm≦R1≦12 mm when the adjacent umbrella spacing is less than 40 mm; 12 mm≦R1≦14 mm when the adjacent umbrella spacing is between 40 mm and 50 mm; and 14 mm≦R1≦16 mm when the adjacent umbrella spacing is greater than 50 mm. In this way, the greater the umbrella spacing is, the greater the corresponding umbrella root chamfer radius is, which helps the composite insulator remain non-oscillating in the strong wind region and operate reliably.

Preferably, the selection is made according to the following structure: when the adjacent umbrella spacing is less than 40 mm, the upper umbrella root chamfer radius R1 is 10 mm or 12 mm, and the lower umbrella root chamfer radius R2 is 12 mm; when the adjacent umbrella spacing is between 40 mm and 50 mm, the upper umbrella root chamfer radius R1 is 10 mm, 12 mm or 14 mm, and the lower umbrella root chamfer radius R2 is 12 mm or 14 mm; and when the adjacent umbrella spacing is greater than 50 mm, the upper umbrella root chamfer radius R1 is 12 mm, 14 mm or 16 mm, and the lower umbrella root chamfer radius R2 is 14 mm or 16 mm. In this way, the composite insulator in an asymmetric umbrella shape corresponding to the above values is selected, and the composite insulator facilitates product design and manufacturing.

For the composite insulator in a symmetric umbrella shape, preferably, in step P2), in the table, the umbrella root chamfer radius R is in the following range of: 10 mm≦R≦12 mm when the adjacent umbrella spacing is less than 40 mm; 12 mm≦R≦14 mm when the adjacent umbrella spacing is between 40 mm and 50 mm; and 14 mm≦R≦16 mm when the adjacent umbrella spacing is greater than 50 mm.

Preferably, the selection is made according to the following structure: the umbrella root chamfer radius R is 10 mm or 12 mm when the adjacent umbrella spacing is less than 40 mm; the umbrella root chamfer radius R is 10 mm, 12 mm or 14 mm when the adjacent umbrella spacing is between 40 mm and 50 mm; and the umbrella root chamfer radius R is 12 mm, 14 mm or 16 mm when the adjacent umbrella spacing is greater than 50 mm. In this way, the composite insulator in a symmetric umbrella shape corresponding to the above values is selected, and the composite insulator facilitates product design and manufacturing.

The embodiments further provide a composite insulator, the composite insulator being of an asymmetric umbrella-shaped structure, and having structure parameters shown in the following table:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | ΔH is less than 40 mm | |
| root | When an adjacent umbrella spacing | 10 mm ≦ R1 ≦ 14 mm |
| chamfer | ΔH is between 40 mm and 50 mm | |
| radius | When an adjacent umbrella spacing | 12 mm ≦ R1 ≦ 16 mm |
| R1 | ΔH is greater than 50 mm | |
| Lower | When an adjacent umbrella spacing | R2 = 12 mm |
| umbrella | ΔH is less than 40 mm | |
| root | When an adjacent umbrella spacing | 12 mm ≦ R2 ≦ 14 mm |
| chamfer | ΔH is between 40 mm and 50 mm | |
| radius | When an adjacent umbrella spacing | 14 mm ≦ R2 ≦ 16 mm |
| R2 | ΔH is greater than 50 mm | |

| | |
|---|---|
| Umbrella skirt diameter difference ΔD of | 0 ≦ ΔD ≦ 40 mm |
| adjacent umbrella skirts | |

Preferably, the upper umbrella root chamfer radius R1: is 10 mm≦R1≦12 mm when the adjacent umbrella spacing is less than 40 mm; is 12 mm≦R1≦14 mm when the adjacent umbrella spacing is between 40 mm and 50 mm; and is 14 mm≦R1≦16 mm when the adjacent umbrella spacing is greater than 50 mm.

Preferably, for the structure parameters of the composite insulator: when the adjacent umbrella spacing is less than 40 mm, the upper umbrella root chamfer radius R1 is 10 mm or 12 mm, and the lower umbrella root chamfer radius R2 is 12 mm; when the adjacent umbrella spacing is between 40 mm and 50 mm, the upper umbrella root chamfer radius R1 is 10 mm, 12 mm or 14 mm, and the lower umbrella root chamfer radius R2 is 12 mm or 14 mm; and when the adjacent umbrella spacing is greater than 50 mm, the upper umbrella root chamfer radius R1 is 12 mm, 14 mm or 16 mm, and the lower umbrella root chamfer radius R2 is 14 mm or 16 mm.

The embodiments further provide a composite insulator, the composite insulator being of a symmetric umbrella-shaped structure, and having structure parameters shown in the following table:

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × tanβ ≧ |
| | | 13 mm |
| Umbrella | When an adjacent umbrella spacing | 10 mm ≦ R ≦ 12 mm |
| root | ΔH is less than 40 mm | |
| chamfer | When an adjacent umbrella spacing | 10 mm ≦ R ≦ 14 mm |
| radius R | ΔH is between 40 mm and 50 mm | |
| | When an adjacent umbrella spacing | 12 mm ≦ R ≦ 16 mm |
| | ΔH is greater than 50 mm | |

| | |
|---|---|
| Umbrella skirt diameter difference ΔD of | 0 ≦ ΔD ≦ 40 mm |
| adjacent umbrella skirts | |

Preferably, the umbrella root chamfer radius R of the composite insulator: is 10 mm≦R≦12 mm when the adjacent umbrella spacing is less than 40 mm; is 12 mm≦R≦14 mm when the adjacent umbrella spacing is between 40 mm and 50 mm; and is 14 mm≦R≦16 mm when the adjacent umbrella spacing is greater than 50 mm.

Preferably, the umbrella root chamfer radius R of the composite insulator: is 10 mm or 12 mm when the adjacent umbrella spacing is less than 40 mm; is 10 mm, 12 mm or 14 mm when the adjacent umbrella spacing is between 40 mm and 50 mm; and is 12 mm, 14 mm or 16 mm when the adjacent umbrella spacing is greater than 50 mm.

The composite insulator in an asymmetric umbrella shape or the composite insulator in a symmetric umbrella shape having the above structure parameters, through particular limitations to the structure parameters, does not oscillate violently when operating in a strong wind region, and is not torn so as not to affect reliable operation of the composite insulator.

As follows, oscillation-starting wind speeds of the composite insulators having the above structure parameters are verified through experiment setting, so as to verify that the composite insulators of the above structure can be applied to a strong wind region, and the problems that umbrella skirts violently oscillate and the umbrella skirts are torn do not occur.

As shown in the following table, composite insulators of an asymmetric structure with a withstand voltage of 750 kV which have structure parameters shown in the following Experiments 1 to 2 and composite insulators of a symmetric structure with a withstand voltage of 750 kV which have structure parameters shown in the following Experiments 3 to 5 are selected according to the selection method of the embodiments. In contrast, according to the existing methods, only electrical characteristics are taken into account for the selection, to select a composite insulator of an asymmetric structure with a withstand voltage of 750 kV, and after the selection, the structure parameters of the composite insulator of an asymmetric structure obtained through measurement are shown in Comparative Examples 1, 2, 3, and 4 in the following table. Then, in the same test environment, oscillation-starting wind speeds of composite insulators in Experiments 1 to 5 and Comparative Examples 1 to 4 are tested, that is, a wind speed at which a composite insulator starts to oscillate or vibrate.

| | D | L1 | L2 | ΔH | R1 | R2 | ΔD | Oscillation-starting wind |
|---|---|---|---|---|---|---|---|---|
| | (mm) | (mm) | (mm) | (mm) | (mm) | (mm) | (mm) | speed (m/s) |
| Experiment | 174 | 4 | 13 | 36 | 10 | 10 | 40 | Still stable at 60 |
| 1 | | | | | | | | m/s |
| Experiment | 185 | 4 | 14 | 26 | 10 | 10 | 40 | Still stable at 50 |
| 2 | | | | | | | | m/s |
| Comparative | 226 | 3.5 | 10.5 | 43 | 40 | 4.5 | 72 | 48.49 |
| Example 1 | | | | | | | | |
| Comparative | 210 | 4 | 13 | 35 | 8 | 4 | 90 | 34.72 |
| Example 2 | | | | | | | | |
| | D | L1 | | D1 | ΔH | R | ΔD | Oscillation-starting wind |
| | (mm) | (mm) | β (°) | (mm) | (mm) | (mm) | (mm) | speed (m/s) |
| Experiment | 150 | 5 | 4.5 | 46 | 42 | 10 | 0 | Still stable at 60 |
| 3 | | | | | | | | m/s |
| Experiment | 190 | 4.5 | 4.5 | 46 | 46 | 12 | 35 | Still stable at 60 |
| 4 | | | | | | | | m/s |
| Experiment | 200 | 4 | 4 | 46 | 43 | 10 | 30 | Still stable at 60 |
| 5 | | | | | | | | m/s |
| Comparative | 195 | 4 | 11 | 35 | 8 | 4 | 80 | 29.62 |
| Example 3 | | | | | | | | |
| Comparative | 186 | 3.5 | 11.4 | 46 | 17.5 | 8.75 | 40 | 42.07 |
| Example 4 | | | | | | | | |

It can be known from the data in the above Experiments 1 to 5 and Comparative Examples 1 to 4 that, the oscillation-starting wind speeds of the composite insulators in the embodiments are all greater than or equal to 50 m/s, and some of the composite insulators may still operate stably at 60 m/s, and can be applied to a strong wind region of 50 m/s, and problems of oscillation and tear of umbrella skirts do not occur. The oscillation-starting wind speeds of the composite insulators having the structure parameters in the Comparative Examples 1 to 4 are all less than 50 m/s, and the composite insulators cannot be applied to the strong wind region.

The above content further describes the present application in detail with reference to some embodiments, and it cannot be determined that specific implementation of the present application is merely limited to the descriptions. Several replacements or obvious variations with the same performance or use made by persons of ordinary skill in the art without departing from the concept of the present application should be regarded as falling within the protection scope of the present application.

What is claimed is:

1. A selection method for a strong wind region composite insulator based on structure parameters, comprising the following steps: 1) measuring structure parameters of a composite insulator to be selected; when the composite insulator is in an asymmetric umbrella shape, the structure parameters comprising an umbrella skirt diameter, an umbrella skirt edge thickness, an umbrella skirt root thickness, an adjacent umbrella spacing, an upper umbrella root chamfer radius, a lower umbrella root chamfer radius and an umbrella skirt diameter difference of adjacent umbrella skirts; when the composite insulator is in a symmetric umbrella shape, the structure parameters comprising an umbrella skirt diameter, an umbrella skirt edge thickness, an upper umbrella inclination angle, a sheath diameter, an adjacent umbrella spacing, a root chamfer radius and an umbrella skirt diameter difference of adjacent umbrella skirts; and 2) selecting a composite insulator in an asymmetric umbrella shape and/or a composite insulator in a symmetric umbrella shape according to the structure parameters shown in the following tables:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | is less than 40 mm | |
| root | When an adjacent umbrella spacing | 10 mm ≦ R1 ≦ 14 mm |
| chamfer | is between 40 mm and 50 mm | |
| radius | When an adjacent umbrella spacing | 12 mm ≦ R1 ≦ 16 mm |
| R1 | is greater than 50 mm | |
| Lower | When an adjacent umbrella spacing | R2 = 12 mm |
| umbrella | is less than 40 mm | |
| root | When an adjacent umbrella spacing | 12 mm ≦ R2 ≦ 14 mm |
| chamfer | is between 40 mm and 50 mm | |
| radius | When an adjacent umbrella spacing | 14 mm ≦ R2 ≦ 16 mm |
| R2 | is greater than 50 mm | |
| | |
|---|---|
| Umbrella skirt diameter difference ΔD of | 0 ≦ ΔD ≦ 40 mm |
| adjacent umbrella skirts | |

and

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × tanβ ≧ |
| | | 13 mm |
| Umbrella | When an adjacent umbrella spacing | 10 mm ≦ R ≦ 12 mm |
| root | is less than 40 mm | |
| chamfer | When an adjacent umbrella spacing | 10 mm ≦ R ≦ 14 mm |
| radius R | is between 40 mm and 50 mm | |
| | When an adjacent umbrella spacing | 12 mm ≦ R ≦ 16 mm |
| | is greater than 50 mm | |
| | |
|---|---|
| Umbrella skirt diameter difference ΔD of | 0 ≦ ΔD ≦ 40 mm |
| adjacent umbrella skirts | |

2. The selection method for a strong wind region composite insulator based on structure parameters according to claim 1, wherein, in the table of step 2), the upper umbrella root chamfer radius R1 of the composite insulator in an asymmetric umbrella shape: is 10 mm≦R1≦12 mm when the adjacent umbrella spacing is less than 40 mm; is 12 mm≦R1≦14 mm when the adjacent umbrella spacing is between 40 mm and 50 mm; and is 14 mm≦R1≦16 mm when the adjacent umbrella spacing is greater than 50 mm.

3. The selection method for a strong wind region composite insulator based on structure parameters according to claim 1, wherein, for the composite insulator in an asymmetric umbrella shape in the table of step 2): when the adjacent umbrella spacing is less than 40 mm, the upper umbrella root chamfer radius R1 is 10 mm or 12 mm, and the lower umbrella root chamfer radius R2 is 12 mm; when the adjacent umbrella spacing is between 40 mm and 50 mm, the upper umbrella root chamfer radius R1 is 10 mm, 12 mm or 14 mm, and the lower umbrella root chamfer radius R2 is 12 mm or 14 mm; and when the adjacent umbrella spacing is greater than 50 mm, the upper umbrella root chamfer radius R1 is 12 mm, 14 mm or 16 mm, and the lower umbrella root chamfer radius R2 is 14 mm or 16 mm.

4. The selection method for a strong wind region composite insulator based on structure parameters according to claim 1, wherein, in the table of step 2), the umbrella root chamfer radius R of the composite insulator in a symmetric umbrella shape: is 10 mm≦R≦12 mm when the adjacent umbrella spacing is less than 40 mm; is 12 mm≦R≦14 mm when the adjacent umbrella spacing is between 40 mm and 50 mm; and is 14 mm≦R≦16 mm when the adjacent umbrella spacing is greater than 50 mm.

5. The selection method for a strong wind region composite insulator based on structure parameters according to claim 1, wherein, the umbrella root chamfer radius R of the composite insulator in a symmetric umbrella shape in the table of step 2): is 10 mm or 12 mm when the adjacent umbrella spacing is less than 40 mm; is 10 mm, 12 mm or 14 mm when the adjacent umbrella spacing is between 40 mm and 50 mm; and is 12 mm, 14 mm or 16 mm when the adjacent umbrella spacing is greater than 50 mm.

6. A composite insulator, the composite insulator being of an asymmetric umbrella-shaped structure, wherein the structure parameters of the composite insulator are shown in the following table:

| | | Composite insulator |
|---|---|---|
| | | in an asymmetric |
| | | umbrella shape |
| Umbrella skirt diameter D | | 150 mm ≦ D ≦ 185 mm |
| Umbrella skirt edge thickness L1 | | 3.8 mm ≦ L1 ≦ 6 mm |
| Umbrella skirt root thickness L2 | | 13 mm ≦ L2 ≦ 16 mm |
| Upper | When an adjacent umbrella spacing | 10 mm ≦ R1 ≦ 12 mm |
| umbrella | is less than 40 mm | |
| root | When an adjacent umbrella spacing | 10 mm ≦ R1 ≦ 14 mm |
| chamfer | is between 40 mm and 50 mm | |
| radius | When an adjacent umbrella spacing | 12 mm ≦ R1 ≦ 16 mm |
| R1 | is greater than 50 mm | |
| Lower | When an adjacent umbrella spacing | R2 = 12 mm |
| umbrella | is less than 40 mm | |
| root | When an adjacent umbrella spacing | 12 mm ≦ R2 ≦ 14 mm |
| chamfer | is between 40 mm and 50 mm | |
| radius | When an adjacent umbrella spacing | 14 mm ≦ R2 ≦ 16 mm |
| R2 | is greater than 50 mm | |
| | |
|---|---|
| Umbrella skirt diameter difference ΔD of | 0 ≦ ΔD ≦ 40 mm |
| adjacent umbrella skirts | |

7. The composite insulator according to claim 6, wherein the upper umbrella root chamfer radius R1 of the composite insulator: is 10 mm≦R1≦12 mm when the adjacent umbrella spacing is less than 40 mm; is 12 mm≦R1≦14 mm when the adjacent umbrella spacing is between 40 mm and 50 mm; and is 14 mm≦R1≦16 mm when the adjacent umbrella spacing is greater than 50 mm.

8. The composite insulator according to claim 6, wherein in the structure parameters of the composite insulator: when the adjacent umbrella spacing is less than 40 mm, the upper umbrella root chamfer radius R1 is 10 mm or 12 mm, and the lower umbrella root chamfer radius R2 is 12 mm; when the adjacent umbrella spacing is between 40 mm and 50 mm, the upper umbrella root chamfer radius R1 is 10 mm, 12 mm or 14 mm, and the lower umbrella root chamfer radius R2 is 12 mm or 14 mm; and when the adjacent umbrella spacing is greater than 50 mm, the upper umbrella root chamfer radius R1 is 12 mm, 14 mm or 16 mm, and the lower umbrella root chamfer radius R2 is 14 mm or 16 mm.

9. A composite insulator, the composite insulator being of a symmetric umbrella-shaped structure, wherein the structure parameters of the composite insulator are shown in the following table:

| | | Composite insulator |
|---|---|---|
| | | in a symmetric |
| | | umbrella shape |
| Umbrella skirt diameter D | | 150 mm ≦ D ≦ 205 mm |
| Umbrella skirt edge thickness L1 | | 3.8 mm ≦ L1 ≦ 6 mm |
| Upper umbrella inclination angle β | | 3.5° ≦ β ≦ 8° |
| Sheath diameter D1 | | L1 + (D − D1) × tanβ ≧ |
| | | 13 mm |
| Umbrella | When an adjacent umbrella spacing | 10 mm ≦ R ≦ 12 mm |
| root | is less than 40 mm | |
| chamfer | When an adjacent umbrella spacing | 10 mm ≦ R ≦ 14 mm |
| radius R | is between 40 mm and 50 mm | |
| | When an adjacent umbrella spacing | 12 mm ≦ R ≦ 16 mm |
| | is greater than 50 mm | |
| | |
|---|---|
| Umbrella skirt diameter difference ΔD of | 0 ≦ ΔD ≦ 40 mm |
| adjacent umbrella skirts | |

10. The composite insulator according to claim 9, wherein the umbrella root chamfer radius R of the composite insulator: is 10 mm≦R≦12 mm when the adjacent umbrella spacing is less than 40 mm; is 12 mm≦R≦14 mm when the adjacent umbrella spacing is between 40 mm and 50 mm; and is 14 mm≦R≦16 mm when the adjacent umbrella spacing is greater than 50 mm.

11. The composite insulator according to claim 9, wherein the umbrella root chamfer radius R of the composite insulator: is 10 mm or 12 mm when the adjacent umbrella spacing is less than 40 mm; is 10 mm, 12 mm or 14 mm when the adjacent umbrella spacing is between 40 mm and 50 mm; and is 12 mm, 14 mm or 16 mm when the adjacent umbrella spacing is greater than 50 mm.
